(19) United States
(12) Patent Application Publication
(10) Pub. No.: US 2015/0231019 A1
(43) Pub. Date: Aug. 20, 2015

(54) Walking Aid Support Assembly

(71) Applicant: Richard G. Warder, SR., Suffolk, VA (US)

(72) Inventor: Richard G. Warder, SR., Suffolk, VA (US)

(21) Appl. No.: 14/184,000

(22) Filed: Feb. 19, 2014

(51) Int. Cl. A61H 3/02

(52) U.S. Cl. CPC A61H 3/02; A61H 2003/005

(57) ABSTRACT

A walking aid support assembly stably supports a leg of a user while using a crutch. The assembly includes a pair of mounting members each having a first flange and a second flange. Each of the second flanges is configured for coupling to a crutch frame. A support member is coupled to each of the first flanges. The support member is configured to support a leg of a user above a ground surface. Each of a pair of braces is coupled to and extends between the support member and an associated one of the mounting members. Each brace has a bottom portion and an upper portion. The bottom portion of each brace is coupled to the first flange of the associated mounting member below the support member. The upper portion of each brace is coupled to a front section of the support member positioned distally relative to the mounting members.

### BACKGROUND OF THE DISCLOSURE

### Field of the Disclosure

The disclosure relates to rehabilitation devices and more particularly pertains to a new rehabilitation device for stably supporting a leg of a user while using a walking aid, such as a crutch.

### SUMMARY OF THE DISCLOSURE

An embodiment of the disclosure meets the needs presented above by generally comprising a pair of mounting members each having a first flange and a second flange. Each of the second flanges is configured for coupling to a crutch frame. A support member is coupled to each of the first flanges. The support member is configured to support a leg of a user above a ground surface. Each of a pair of braces is coupled to and extends between the support member and an associated one of the mounting members. Each brace has a bottom portion and an upper portion. The bottom portion of each brace is coupled to the first flange of the associated mounting member below the support member. The upper portion of each brace is coupled to a front section of the support member positioned distally relative to the mounting members.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a walking aid support assembly according to an embodiment of the disclosure.

FIG. 2 is a side view of an embodiment of the disclosure.

FIG. 3 is a front view of an embodiment of the disclosure.

FIG. 4 is a front view of an alternative embodiment of the disclosure in use.

### DESCRIPTION OF THE PREFERRED EMBODIMENT

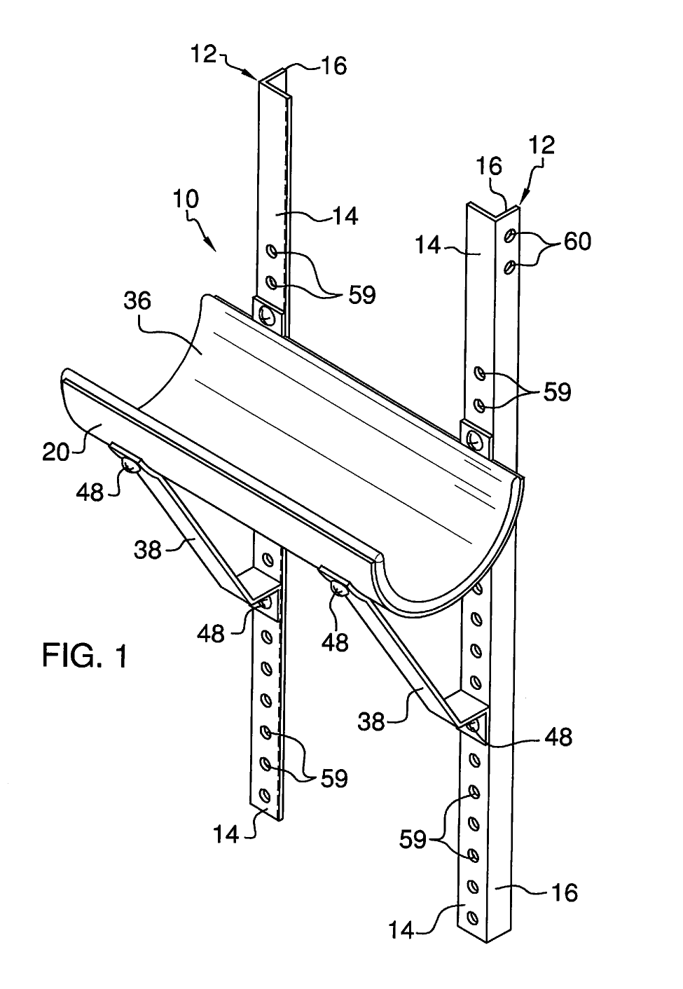

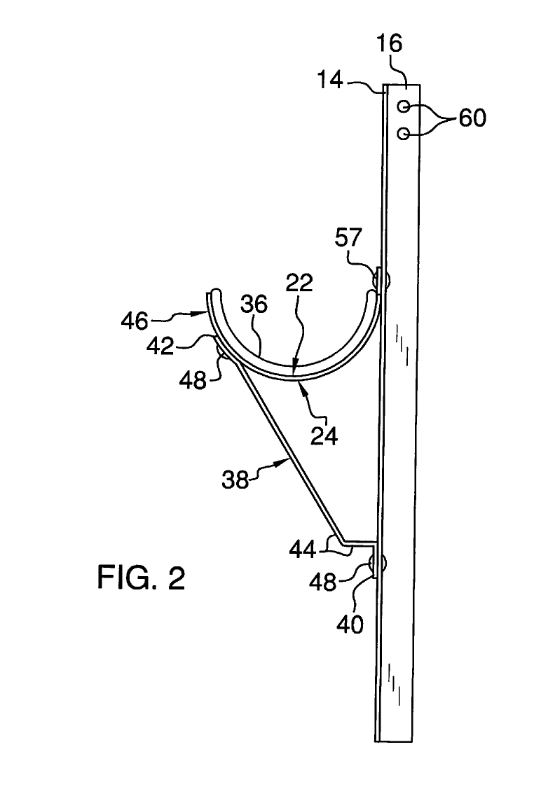

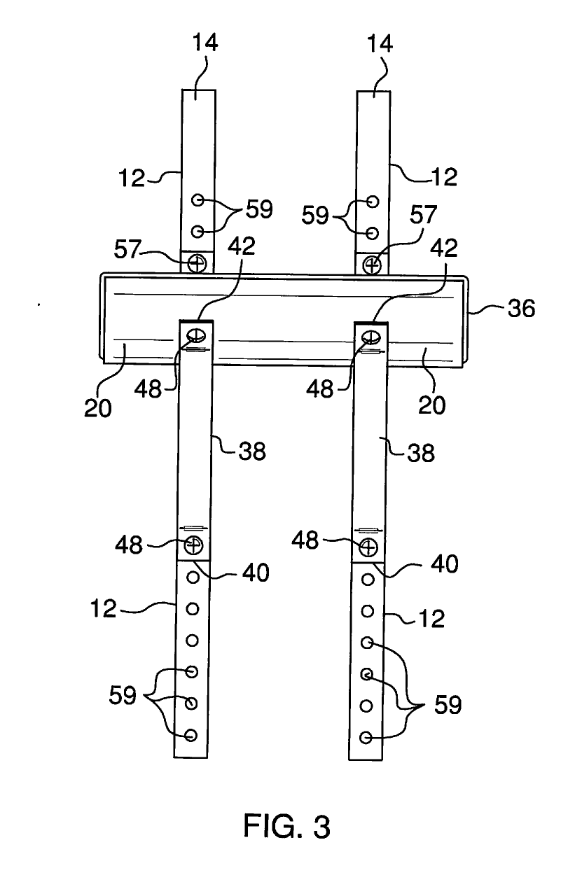

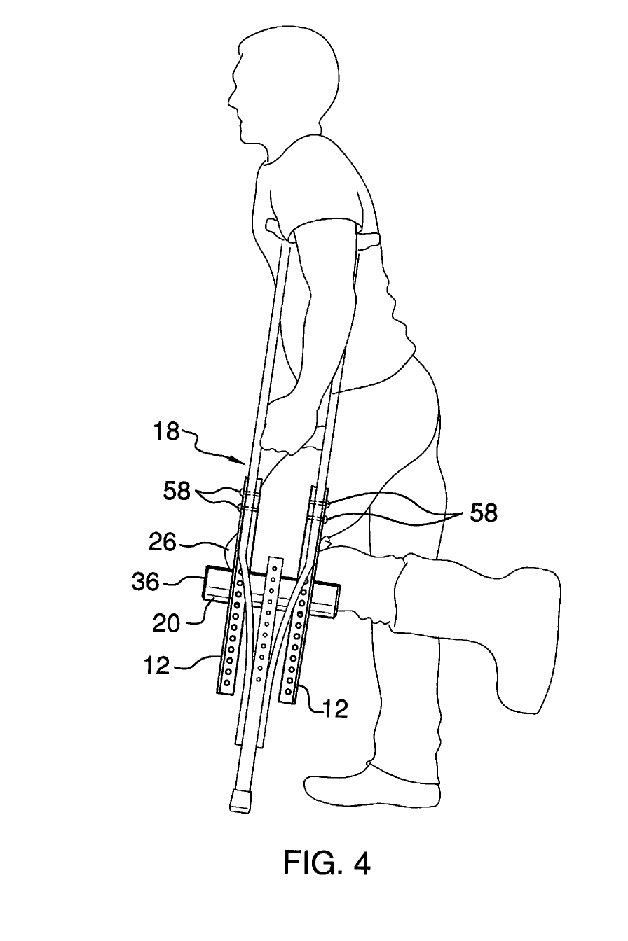

With reference now to the drawings, and in particular to FIGS. 1 through 4 thereof, a new rehabilitation device embodying the principles and concepts of an embodiment of the disclosure and generally designated by the reference numeral 10 will be described.

As best illustrated in FIGS. 1 through 4, the walking aid support assembly 10 generally comprises a pair of mounting members 12 each having a first flange 14 and a second flange 16. Each of the first flanges 14 may be positioned perperdicularly relative to each of the second flanges 16. The second flange 16 of each mounting member 12 is configured for coupling to a crutch frame 18. Each of the mounting members 12 may be constructed from aluminum or a similar rigid material.

A support member 20 is coupled to each of the first flanges 14. The support member 20 has an upper surface 22 and a lower surface 24. The upper surface 22 is configured to receive and support a leg 26 of a user above a ground surface. The support member 20 may also be constructed from aluminum or similar rigid material. A longitudinal axis of the support member 20 is positioned transverse relative to the mounting members 12. The upper surface 22 of the support member 20 may be concavely arcuate. The support member 20 is positionable at a selectable location on the mounting members 12 such that the support member 20 is spaced at a selectable height from the ground surface. A pad 36 is coupled to the upper surface 22 of the support member 20. The pad 36 may be adhesively coupled to the upper surface 22. The pad 36 may be constructed from rubber foam or the like.

A pair of braces 38 is provided. Each of the braces 38 is coupled to and extends between the support member 20 and an associated one of the mounting members 12. Each of the braces 38 has a bottom portion 40 and an upper portion 42. The bottom portion 40 of each brace 38 is coupled to the first flange 14 of the associated mounting member 12 below the support member 20. The upper portion 42 of each brace 38 is coupled to a front section 46 of the support member 20 positioned distally relative to the mounting members 12. A plurality of brace fasteners 48, such as rivets, screws or the like, couples the braces 38 to the support member 20 and to each of the mounting members 12.

A plurality of aligned apertures 60 is positioned in each of the second flanges 16. The apertures 60 are configured for positioning in alignment with selectable openings in the crutch frame 18 such that the apertures 60 and the associated openings receive a mounting fastener 58 therethrough to attach the mounting members 12, and thus the support member 20, to the crutch frame 18. The mounting fasteners 58 may comprise screws or other conventional fasteners. A plurality of aligned holes 59 is positioned in each of the first flanges 14. A pair of couplers 57 is provided. Each of the couplers 57 is insertable into and engages a selectable one of the holes 59 on each of the mounting members 12 to permit adjustment of a height of the support member 20 relative to the ground surface. In particular, the adjustable nature of the support member 20 permits the lower surface 24 of the support member 20 to be selectively positionable at a distance between approximately 40.0 centimeters and 70.0 centimeters above the ground surface. Adjacently positioned holes 59 may be spaced approximately 1.0 centimeter and 4.0 centimeters apart.

In use, as stated above and shown in the Figures, the assembly 10 is attached to a walking aid, such as a crutch frame 18. An injured leg 26 is positioned on the pad 36. In this manner, the user's leg 26 is supported above the ground surface, is immobilized while positioned on the pad 36, and moves simultaneously with the walking aid. A height of the assembly 10 can be adjusted relative to the ground surface to suit the particular needs of the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A walking aid support assembly comprising:
a pair of mounting members each having a first flange and a second flange, each of said second flanges being configured for coupling to a crutch frame;
a support member being coupled to each of said first flanges, said support member having an upper surface configured to receive and support a leg of a user above a ground surface; and
a pair of braces each being coupled to and extending between said support member and an associated one of said mounting members, each said brace having a bottom portion and an upper portion, said bottom portion of each said brace being coupled to said first flange of said associated mounting member below said support member, said upper portion of each said brace being coupled to a front section of said support member positioned distally relative to each of said mounting members.

2. The assembly of claim 1, further comprising a longitudinal axis of said support member being positioned transverse relative to said mounting members.

3. The assembly of claim 1, further comprising said upper surface of said support member being concavely arcuate.

4. The assembly of claim 1, further comprising a pad coupled to said upper surface of said support member.

5. The assembly of claim 1, further comprising a plurality of brace fasteners coupling said braces to said support member and to each of said mounting members.

6. The assembly of claim 1, further comprising said support member being positionable at a selectable location on said mounting members such that said support member is spaced at a selectable height from the ground surface.

7. The assembly of claim 6, further comprising:
a plurality of aligned holes positioned in each of said first flanges; and
a pair of couplers, each of said couplers being insertable into and engageable with a selectable one of said holes on each of said mounting members to permit adjustment of a height of said support member relative to the ground surface.

8. The assembly of claim 1, further comprising a plurality of aligned apertures positioned in each of said second flanges, said apertures being configured for positioning in alignment with selectable openings in the crutch frame for attachment of said mounting members to the crutch frame.

9. A walking aid support assembly comprising:
a pair of mounting members each having a first flange and a second flange, each of said second flanges being configured for coupling to a crutch frame;
a support member being coupled to each of said first flanges, said support member having an upper surface configured to receive and support a leg of a user above a ground surface, said upper surface of said support member being concavely arcuate, a longitudinal axis of said support member being positioned transverse relative to said mounting members, said support member being positionable at a selectable location on said mounting members such that said support member is spaced at a selectable height from the ground surface;
a plurality of aligned holes positioned in each of said first flanges;
a pair of couplers, each of said couplers being insertable into and engageable with a selectable one of said holes on each of said mounting members to permit adjustment of a height of said support member relative to the ground surface;
a pad coupled to said upper surface of said support member;
a plurality of aligned apertures positioned in each of said second flanges, said apertures being configured for positioning in alignment with selectable openings in the crutch frame for attachment of said mounting members to the crutch frame;
a pair of braces each being coupled to and extending between said support member and an associated one of said mounting members, each said brace having a bottom portion and an upper portion, said bottom portion of each said brace being coupled to said first flange of said associated mounting member below said support member, said upper portion of each said brace being coupled to a front section of said support member positioned distally relative to each of said mounting members; and
a plurality of brace fasteners coupling said braces to said support member and to each of said mounting members.
